(19) United States
(12) Patent Application Publication
(10) Pub. No.: US 2026/0110590 A1
(43) Pub. Date: Apr. 23, 2026

(54) LEAK DETECTION SYSTEM FOR RECIPROCATING COMPRESSOR OF HYDROGEN REFUELING STATION

(71) Applicant: KOREA GAS TECHNOLOGY CORPORATION, Daejeon (KR)

(72) Inventors: Kyungduk KIM, Daejeon (KR); Yangjoong KWON, Daejeon (KR); lnjae KIM, Daejeon (KR)

(21) Appl. No.: 19/277,155

(22) Filed: Jul. 22, 2025

(30) Foreign Application Priority Data
Oct. 22, 2024 (KR) 10-2024-0144867

(51) Int. Cl. G01M 3/32

(52) U.S. Cl. CPC G01M 3/3209

(57) ABSTRACT

The present disclosure relates to a leak detection system for a reciprocating compressor of a hydrogen refueling station, the leak detection system capturing characteristics of hydrogen leaks in the reciprocating compressor by using sensor data generated at the hydrogen refueling station and estimated values from a simulation model, and diagnosing a leak point with high accuracy using machine learning.

### CROSS-REFERENCE TO RELATED APPLICATION

This application claims priority to Korean Patent Application No. 10-2024-0144867, filed on Oct. 22, 2024, the entire disclosure of which is hereby incorporated herein by reference.

### BACKGROUND

### 1. Field of the Invention

The present disclosure relates to a leak detection system for a reciprocating compressor of a hydrogen refueling station, and more specifically, to a leak detection system that implements characteristics of hydrogen leaks in the reciprocating compressor by using sensor data generated at the hydrogen refueling station and estimated values from a simulation model, and that diagnoses leak points with high accuracy using machine learning.

### 2. Description of the Related Art

A hydrogen refueling station serves a crucial role in supplying hydrogen to Fuel Cell Electric Vehicles (FCEVs) as infrastructure for a hydrogen society. The technology of a hydrogen refueling station includes complex technology such as hydrogen production, transportation, storage, high-pressure equipment, operation control, refueling, and safety measures.

FIG. 1 shows a schematic diagram of a high-pressure gas hydrogen refueling station. Hydrogen produced at a hydrogen production site is transported to the hydrogen refueling station via tube trailers at approximately 200 bar, then pressurized to approximately 875 bar using medium-pressure and high-pressure compressors and temporarily stored in compression vessels. The hydrogen is then dispensed to an FCEV at approximately 700 bar by controlling the flow rate with a dispenser and using differential pressure. When an FCEV is refueled and the pressure in the storage container of the refueling station drops to or below a certain level, a compressor operates to maintain the pressure in the tank.

The compressor is one of the components that often fails at hydrogen refueling stations. The reciprocating compressor of a hydrogen refueling station is a critical component in the refueling process. The reciprocating compressor increases the pressure of hydrogen gas to a high level, stores the compressed hydrogen in a compression vessel, and supplies the hydrogen to the hydrogen tank of an FCEV by controlling the flow rate through a dispenser. Strict safety and reliability standards are required for the reciprocating compressor. One of the faults that may have a critical impact on the compressor is a gas leak in a piston or valve inside the compressor cylinder.

The analysis of data from the hydrogen refueling station located in Seosan, South Korea, reveals that the frequency of hydrogen leak faults from December 2020 to July 2023 is 34 incidents, and the Mean Time To Repair (MTTR) due to the hydrogen leaks is 30 hours. The occurrence of a hydrogen leak may disrupt the operation of a hydrogen refueling station, and increase the likelihood of secondary faults, such as wear, loosening, and vibration of associated components caused by the leak. Therefore, there is a need for monitoring technology that may accurately and quickly detect and replace hydrogen leaks.

For example, Korean Patent Laid-Open Publication No. 10-2022-0085830, entitled “Leakage Detection,” published on Jun. 22, 2022, is incorporated by reference herein.

### SUMMARY

The present disclosure has been made in view of the above-described necessity, and provides a leak detection system for a reciprocating compressor of a hydrogen refueling station, the leak detection system being capable of determining whether a hydrogen leak has occurred and identifying leak points with high accuracy, by utilizing sensor data generated at the hydrogen refueling station and estimated values from a simulation model.

An aspect of the present disclosure provides a leak detection system for a reciprocating compressor of a hydrogen refueling station in which an outlet is connected to a storage container and pressure within the storage container is maintained at or above a set pressure, the leak detection system including: a data collection module configured to collect measurement data, including temperature and pressure from a sensor associated with the reciprocating compressor of the hydrogen refueling station, and a volumetric efficiency, which is a ratio of gas mass drawn into a cylinder during an intake stroke to gas mass corresponding to a stroke volume; a simulator module configured to perform an operational simulation based on design values of the reciprocating compressor and generate virtual data including temperature, pressure, and volumetric efficiency; and a data processing module including: a comparator configured to compare the measurement data and the virtual data; a selector configured to select measurement data corresponding to each hydrogen leak point input based on inspection and maintenance data associated with abnormalities in the reciprocating compressor; and an estimator configured to estimate abnormal conditions from the measurement data in conjunction with the comparator and the selector.

Here, the measurement data and the virtual data may further include operational information of the reciprocating compressor, motor current, and vehicle pressure and mass flow rate measured at a hydrogen dispenser.

Additionally, the data collection module may include: an input section configured to receive specification information of the reciprocating compressor; and a calculation section configured to calculate the volumetric efficiency based on the specification information, gas mass flow rate, density, and nominal stroke volume, wherein the gas mass flow rate may be determined by applying a mass flow rate estimated based on mass and energy conservation equations at the pressure and temperature of the storage container.

Furthermore, the maintenance data may include leaks in an inlet valve, an outlet valve, and a cylinder packing.

The present disclosure enables high-accuracy detection of hydrogen leaks, which often occur in the reciprocating compressor that serves as a core component of a hydrogen refueling station, and allows estimation of the leak point. This supports efficient maintenance by performing proactive and planned maintenance in real-world equipment management.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

These and/or other aspects, features, and advantages of the invention will become apparent and more readily appreciated from the following description of embodiments, taken in conjunction with the accompanying drawings of which:

FIG. 1 shows a schematic diagram of a high-pressure gas hydrogen refueling station.

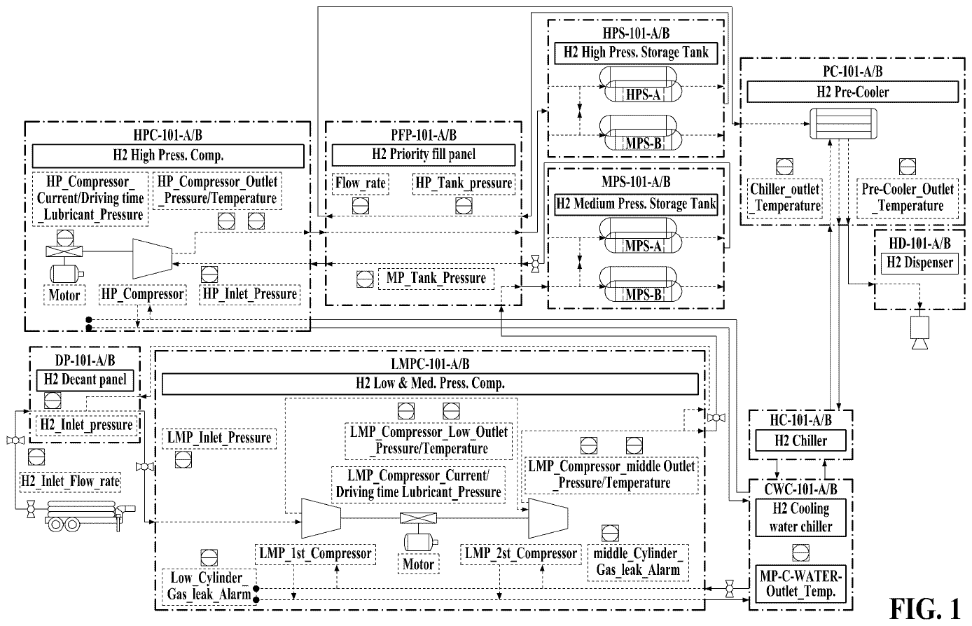

FIG. 2 shows a block diagram illustrating a configuration and connection relationship according to an embodiment of the present disclosure.

FIG. 3 shows a Simscape-based model of a hydrogen refueling station compressor system.

FIG. 4A shows a Simscape-based model of a hydrogen refueling station compressor system.

FIG. 4B shows a Simscape-based model of a hydrogen refueling station compressor system.

FIG. 5 shows a comparison graph of measurement data and simulation data for compressor pressure (high-pressure (HP)).

FIG. 6 shows a comparison graph of measurement data and simulation data for compressor pressure (medium-pressure (MP)).

FIG. 7 shows a Simscape-based detailed model for parameter estimation.

FIG. 8 shows a graph illustrating volumetric efficiency in relation to leaks in a reciprocating compressor cylinder.

FIG. 9A shows a comparison result between measurement data and simulation data according to an embodiment of the present disclosure.

FIG. 9B shows a comparison result between measurement data and simulation data according to an embodiment of the present disclosure.

FIG. 9C shows a comparison result between measurement data and simulation data according to an embodiment of the present disclosure.

FIG. 9D shows a comparison result between measurement data and simulation data according to an embodiment of the present disclosure.

FIG. 10A shows a distribution and scatter plot for each leak point according to an embodiment of the present disclosure.

FIG. 10B shows a distribution and scatter plot for each leak point according to an embodiment of the present disclosure.

FIG. 11 shows confusion matrix results classified by the neural network technique according to an embodiment of the present disclosure.

### DETAILED DESCRIPTION

Project Unique Number: 2410007817
Project Number: RS-2022-KP002759
Ministry: Ministry of Trade, Industry and Energy (MOTIE), Korea government
Managing Agency: Korea Institute of Energy Technology Evaluation and Planning (KETEP)
R&D Program Title: Development of Core Components and Facility Safety Technologies for Liquid Hydrogen Refueling
R&D Project Title: Safety Evaluation/Demonstration and Development of Safety Standards for the Establishment of Liquid Hydrogen Refueling Stations
Lead R&D Organization: Korea Gas Technology Corporation
Performing Organization: Korea Gas Technology Corporation
Research Period: Apr. 1, 2022-Sep. 30, 2025

Hereinafter, a leak detection system for a reciprocating compressor of a hydrogen refueling station according to an embodiment of the present disclosure will be described in detail with reference to the accompanying drawings.

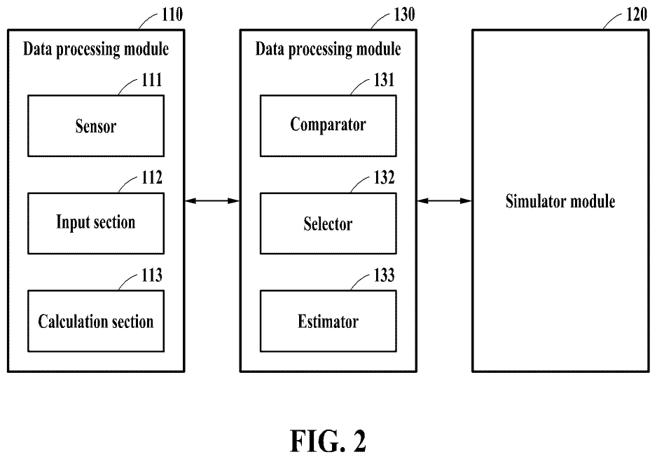

FIG. 2 shows a block diagram illustrating the configuration and connection relationships according to an embodiment of the present disclosure. The present disclosure may include a data collection module 110, a simulator module 120, and a data processing module 130 as a main configuration for detecting a gas leak in a compressor cylinder and valve, which is one of the faults that critically affect the reciprocating compressor of a gas refueling station.

As mentioned earlier, the reciprocating compressor of the hydrogen refueling station may operate such that an outlet is connected to a storage container and the pressure within the storage container is maintained at or above a set pressure. The data collection module 110 may collect measurement data, including temperature and pressure from a sensor 111 associated with the reciprocating compressor of the hydrogen refueling station, and a volumetric efficiency, which is a ratio of a gas mass drawn into a cylinder during an intake stroke to a gas mass corresponding to the stroke volume.

The sensor 111 may be primarily a sensor for measuring pressure and temperature, and may be installed at designated locations on pipes connecting an inlet valve side and an outlet valve side of the reciprocating compressor, as well as a storage tank and a dispenser that supplies hydrogen to vehicles.

Here, in order to calculate the volumetric efficiency, the data collection module 110 may include:
an input section 112 configured to receive specification information of the reciprocating compressor; and a calculation section 113 configured to calculate the volumetric efficiency based on the specification information, gas mass flow rate, density, and nominal stroke volume, wherein the gas mass flow rate may be determined by applying a mass flow rate estimated based on mass and energy conservation equations at the pressure and temperature of the storage container.

A leak within the cylinder of a reciprocating compressor may be estimated primarily through methods such as a pressure-volume (P-V) diagram, using compression ratio, volumetric efficiency, and polytropic index. The P-V diagram may be obtained by comparing the pressure and volume inside the cylinder based on the measurements of the crankshaft angle of the reciprocating compressor. By comparing the form of a perfect card P-V diagram with that of a deformed P-V diagram, which fails to reach the target pressure due to a gas leak, it is possible to identify abnormal conditions of the compressor.

Among these, the variable most affected is the volumetric efficiency, which refers to a ratio of a gas mass drawn into the cylinder during an intake stroke of the reciprocating compressor to a gas mass corresponding to the stroke volume, and is defined by [Equation 1].

$$η V = \frac{{m}_{cycle}}{{ρV}_{disp}} \qquad [ Equation 1 ]$$

wherein ηV denotes the volumetric efficiency, m_{cycle} denotes the gas flow rate, p denotes the density, and V_{disp} denotes the nominal stroke volume. The gas flow rate transferred during one cycle of the piston reciprocating within the cylinder of the reciprocating compressor is as shown in [Equation 2].

$${m}_{cycle} = α \cdot ηV \cdot S \cdot \frac{{π D}^{2}}{4} \cdot \frac{P}{ZRT} \qquad [ Equation 2 ]$$

wherein α denotes a coefficient that considers the change in the flow direction and the contraction of the gas flow, and is assumed to be 1. Additionally, S denotes the stroke, D denotes the piston diameter,

$$S \cdot \frac{π {D}^{2}}{4}$$

denotes the stroke volume, and P/ZRT denotes the density.

When the process of compressing gas and the reciprocating motion of a piston within a cylinder operate as a normal polytropic process, a perfect card P-V diagram is formed when using a gas equation. Here, the volumetric efficiency may be calculated using [Equation 3] based on compression clearance ratio, compression ratio, and polytropic index.

$$η V = \frac{1 - {C ϵ}^{1 / n}}{1 - C} \qquad [ Equation 3 ]$$

wherein C denotes the compression clearance ratio, n denotes the polytropic index, and ϵ denotes the compression ratio.

However, when a gas leak occurs and the polytropic process can no longer be applied, as in the case of a deformed P-V diagram, the volumetric efficiency can no longer be calculated using [Equation 3], and must instead be calculated using [Equation 1] based on the gas mass flow rate and the nominal stroke volume.

However, installation of a flow meter to measure the mass flow rate of hydrogen in a hydrogen refueling station may involve issues such as high installation costs and hazards arising from cutting the piping. Thus, the mass flow rate may be indirectly estimated based on the mass and energy conservation equations in the storage container connected to the outlet of the reciprocating compressor.

The pressure and temperature may be measured using the sensor installed in the storage container, and in thermal equations, the following equations may be calculated based on the mass and enthalpy entering and exiting port i, as well as heat transfer.

$$[ \begin{matrix}V \cdot {( \frac{\partial ρ}{\partial p} )}_{T} & V \cdot {( \frac{\partial ρ}{\partial T} )}_{p} \\ m \cdot {( \frac{\partial h}{\partial p} )}_{T} & m \cdot {( \frac{\partial h}{\partial T} )}_{p}\end{matrix} ] \cdot [ \begin{matrix}\frac{dp}{dt} \\ \frac{dT}{dt}\end{matrix} \text{} ] = [ \text{} \begin{matrix}Σ \frac{{dm}_{i}}{dt} - ρ \frac{d V}{dt} \\ Σ \frac{{dm}_{i}}{dt} \cdot {h}_{i} - h Σ \frac{{dm}_{i}}{dt} + δ Q\end{matrix} \text{} ] \qquad [ Equation 4 ]$$

$$\frac{dp}{dt} = p \cdot k ( \frac{\dot{m}}{m} - \frac{1}{V} \frac{d V}{dt} ) \qquad [ Equation 5 ]$$

$$\frac{dT}{dt} = \frac{T}{p} \cdot \frac{k - 1}{k} \frac{dp}{dt} \qquad [ Equation 6 ]$$

The equations organized as above are sufficient to determine the variables, and the residual of a specific variable can be obtained from overdetermined elements. This may allow the volumetric efficiency to be calculated when a gas leak occurs in the reciprocating compressor cylinder.

In an embodiment, the simulator module 120 performs an operational simulation based on the design values of the reciprocating compressor and generates virtual data including temperature, pressure, and volumetric efficiency. In the present disclosure, as a method of diagnosing a fault, that is, a leak, in a reciprocating compressor at a hydrogen refueling station, measurement data collected through the operation of actual refueling equipment and a numerical analysis model are constructed using MATLAB Simulink. An operational simulation is then performed based on the design values of the reciprocating compressor, generating virtual data including temperature, pressure, and volumetric efficiency. By comparing and analyzing the measurement data and the virtual data, the residuals of temperature, pressure, and volumetric efficiency values under normal and abnormal conditions, that is, when a leak occurs, are compared.

When constructing the numerical analysis model according to the simulator module 120, each component of the high-pressure hydrogen refueling station process was modeled using blocks from the Gas domain of Simscape Fluids. The physical properties of hydrogen gas in the system model were based on data provided by the National Institute of Standards and Technology (NIST), and both the overall structure of the simulator and the engineering data were configured using the design data of the reciprocating compressor.

Here, the measurement data and the virtual data may further include operational information of the reciprocating compressor, motor current, and vehicle pressure and mass flow rate measured at a hydrogen dispenser.

[Table 1] shows data related to the reciprocating compressor among the measurement data collected at the hydrogen charging station. The status data is required as a control signal sequence for the reciprocating compressor to input the operational signals of the simulator. Among the analog data, the motor current of the reciprocating compressor driving motor, as well as the vehicle pressure and mass flow rate measured at the dispenser, are used as input data and initial setting values.

TABLE 1

| Code | Contents |
|---|---|
| Alarm | Cylinder gas leak |
| Status | Compressor Running |
| | Inlet Gate Valve Open/Close |
| | Outlet Gate Valve Open/Close |
| | Bypass Gate Valve Open/Close |
| | Left Gate Valve Control ON |
| | Right Gate Valve Control ON |
| | Cooling Water Chiller Run |
| | Hydrogen Chiller Run |
| | Equipment Shutdown |
| Analog | Storage Pressure |
| | Compressor Current |
| | Compressor Inlet Pressure |
| | Compressor Outlet Pressure |
| | Compressor Inlet Temperature |
| | Compressor Outlet Temperature |
| | Dispensor Vehicle Pressure |

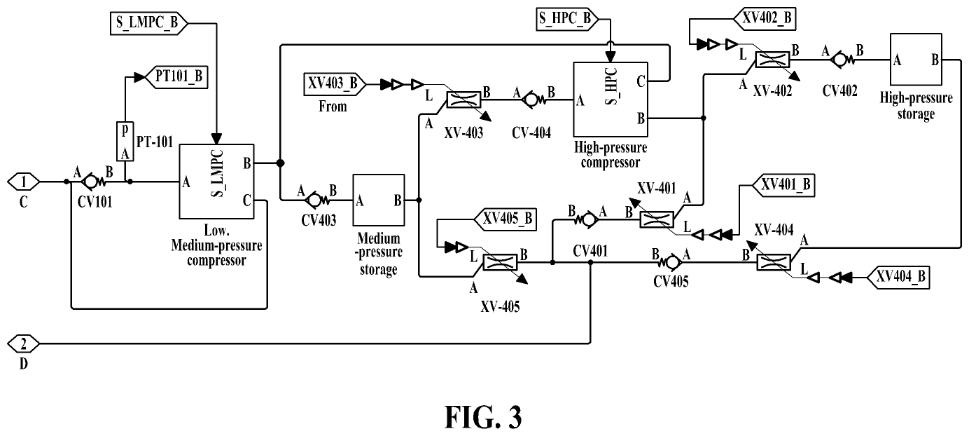

In addition, to accurately reflect the measurement data from the target hydrogen refueling station under operation, components such as a pressure relief valve, a vent line, and a bypass line were modeled in the simulator based on actual drawings. [Table 2] shows the specification information of the reciprocating compressor involved in an embodiment of the present disclosure, and FIG. 3 shows a Simscape-based model of a hydrogen refueling station compression system.

TABLE 2

| Specification | Value | Unit |
|---|---|---|
| Nominal volumetric efficiency | 0.5711 | |
| Nominal mass flow rate | 0.0165 | kg/s |
| Nominal clearance ratio | 0.4819 | |
| Piston displacement | 1.11E−04 | m3 |
| Voltage | 380 | V |
| Power efficiency | 0.75 | |
| Mechanical efficiency | 0.72 | |
| Polytropic index | 1.408 | |
| Bore | 28 | mm |
| Stroke | 180 | mm |
| Piston displacement | 180 | mm |
| Piston speed | 2.64 | m/s |
| Rotational speed of compressor | 440 | rpm |
| Type of valves | Poppet | |
| Cylinder liner | Dry | |
| Acting | Single | |

The data processing module 130 may compare the measurement data and the virtual data, which are respectively collected from the data collection module 110 and the simulator module 120, to detect a leak in the reciprocating compressor, and include, as detailed components for this purpose, a comparator 131, a selector 132, and an estimator 133.

The comparator 131 may compare the measurement data and the virtual data. Based on the normal condition of the equipment, it may be ideal for the measurement data to be identical to the virtual data. However, due to external conditions such as installation conditions of the equipment, external temperature, and atmospheric pressure, differences may occur. Amid these circumstances, the trend of data change caused by the occurrence of abnormal conditions, represented by a hydrogen leak, may be identified.

The selector 132 may select measurement data corresponding to each hydrogen leak point input based on inspection and maintenance data associated with abnormalities in the reciprocating compressor. The selector 132 may detect future abnormalities by learning differences in measurement data collected under abnormal conditions, including leaks in the inlet valve, outlet valve, and cylinder packing. That is, when abnormalities occur while measurement data is being continuously collected and stored over time, changes in the data are observed. In response, alerts or alarms are issued to notify the abnormal conditions, prompting on-site operators to take appropriate actions such as repairs. These facts are then documented as inspection and maintenance data. The measurement data corresponding to this inspection and maintenance data represents measurement data collected under abnormal conditions and corresponding to each hydrogen leak point, and may be utilized as evidence and reference data for future detection of abnormal conditions.

The estimator 133 may estimate abnormal conditions from the measurement data in conjunction with the comparator 131 and the selector 132. Basically, while the measurement data is collected and accumulated and compared with the virtual data for trend monitoring, the occurrence of an abnormality in the reciprocating compressor may be determined based on the trend of changes in the measurement data compared with the virtual data. Furthermore, the hydrogen leak point may be estimated through comparison with changes in pre-selected and learned measurement data corresponding to each hydrogen leak point.

The validation results of the simulator model applied to the simulator module 120 according to an embodiment of the present disclosure were obtained using an observer-based technique for temperature and pressure as follows.

As mentioned above, when the dispenser of the hydrogen refueling station controls the flow rate and dispenses hydrogen to an FCEV by means of differential pressure, the pressure in the medium-pressure and high-pressure storage containers decreases to a certain level. In this case, the reciprocating compressor operates to maintain the pressure of the storage container, resulting in receiving numerous signals from the related sensors.

Among model-based data analysis techniques, the observer-based technique may allow comparison between the measurement data measured from the actual equipment sensors and the virtual data, which are estimated state quantities based on the control signals of the simulator process, to determine the similarity between the actual device of the reciprocating compressor and the numerical analysis model by obtaining the residual.

Therefore, a comparison was made between the measurement data, which are the analog values measured by the actual equipment sensors regarding the pressure and temperature at each of the medium-pressure and high-pressure outlets of the reciprocating compressor, as well as the pressure and temperature at the medium-pressure and high-pressure vessels connected to the inlet and the outlet of the reciprocating compressor in the entire hydrogen refueling station equipment, and the analog values calculated by inputting the virtual data as status data to an analysis model constructed using MATLAB Simscape.

The measurement data measured from the actual sensors includes signals from components under abnormal conditions, whereas the values estimated from the analysis model according to the simulator module 120 include only signals from components under normal conditions. Therefore, the signals of fault components may be estimated through the differences between these two values.

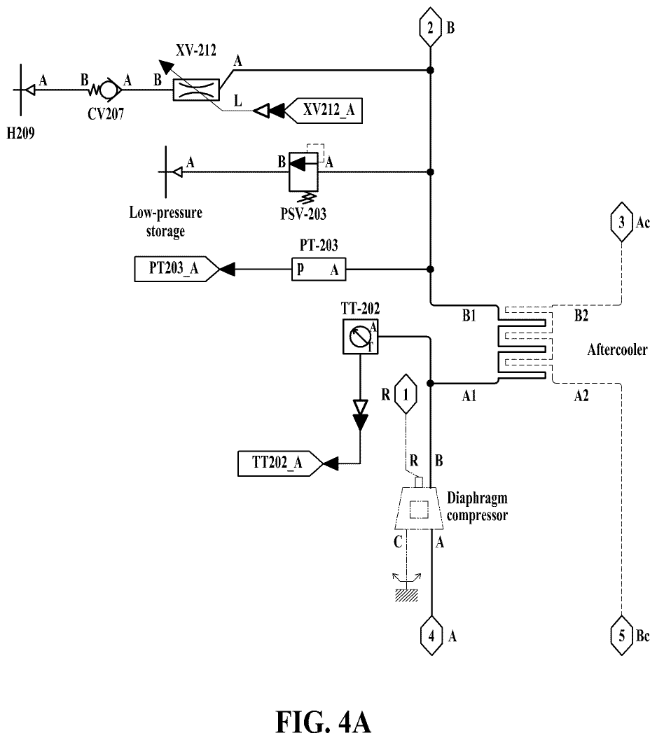

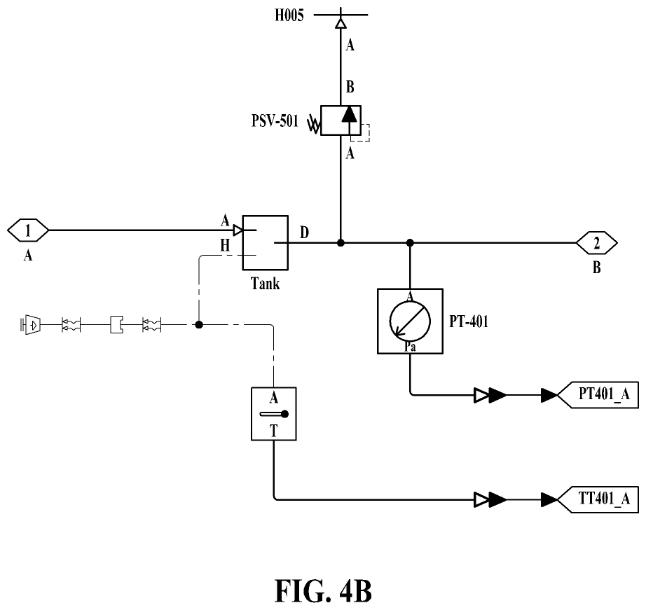

FIG. 4A and FIG. 4B show a Simscape-based model of a hydrogen refueling station compressor system. The simulator, that is, the numerical analysis model for generating observers of the components of the hydrogen refueling station process such as the reciprocating compressor, was calibrated and validated using manufacturer data through MATLAB Simscape based on the modeled thermodynamic relationships.

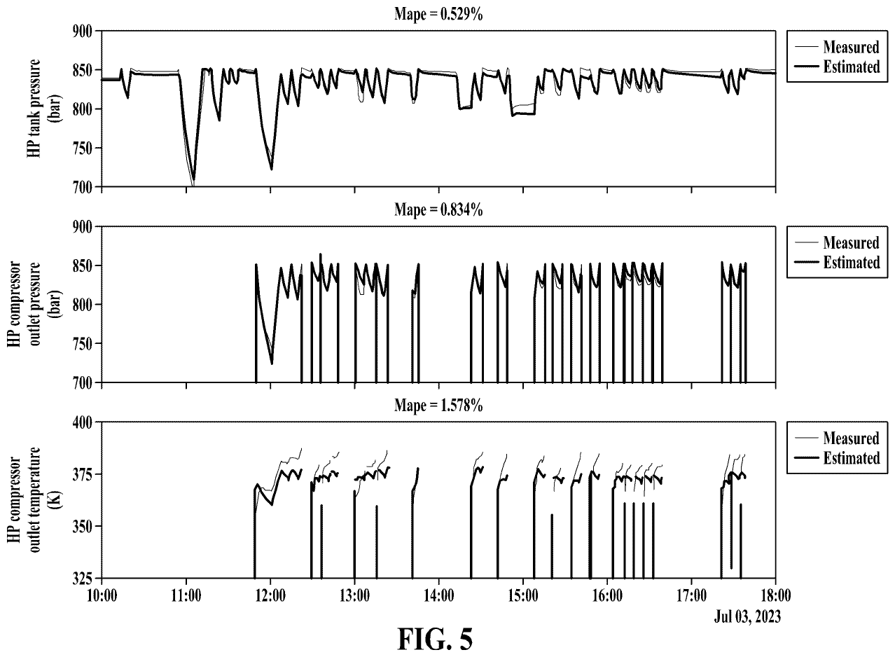

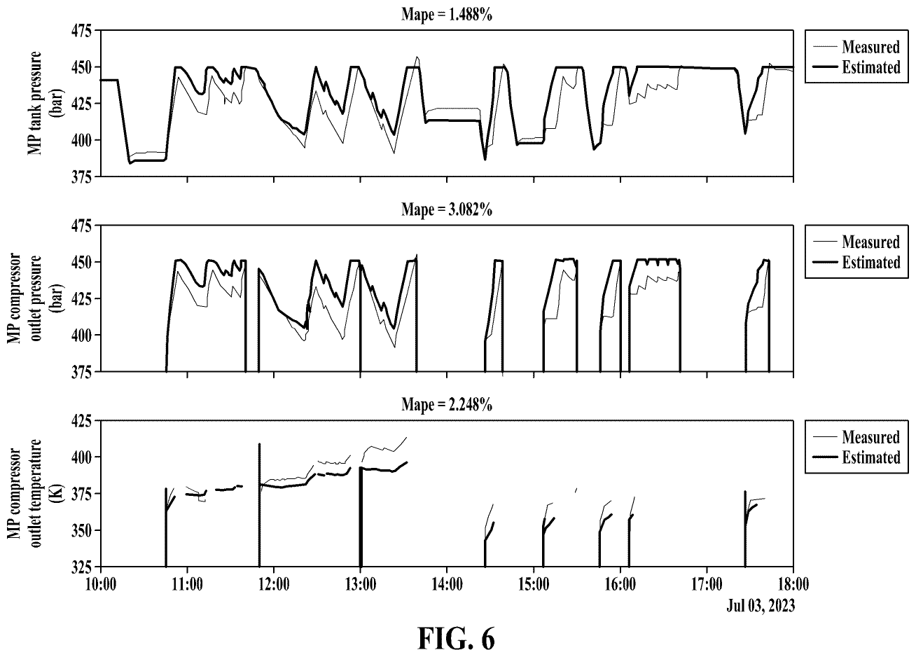

FIG. 5 shows a comparison graph of measurement data and simulation data for compressor pressure (high-pressure (HP)), and FIG. 6 shows a comparison graph of measurement data and simulation data for compressor pressure (medium-pressure (MP)). These figures show the results of comparing the actually measured measurement data with the virtual data of the analysis model of the simulator module 120, and targeting operation data of the hydrogen refueling station when there has been no fault alarm. The performance indicator for the analysis model data uses Mean Absolute Percentage Error (MAPE), and the MAPE values for the high-pressure and medium-pressure tanks showed 0.53% and 1.48%, respectively. Additionally, in the case of the MAPE values for the pressures at the outlets of the high-pressure and medium-pressure compressors, 0.83% and 3.08% were shown, respectively, while for the temperatures, 1.57% and 2.24% were shown.

In this manner, the MAPE value is 5% or less, demonstrating that the numerical analysis model according to the simulator module 120 is similar to the actual equipment in terms of similarity and accuracy.

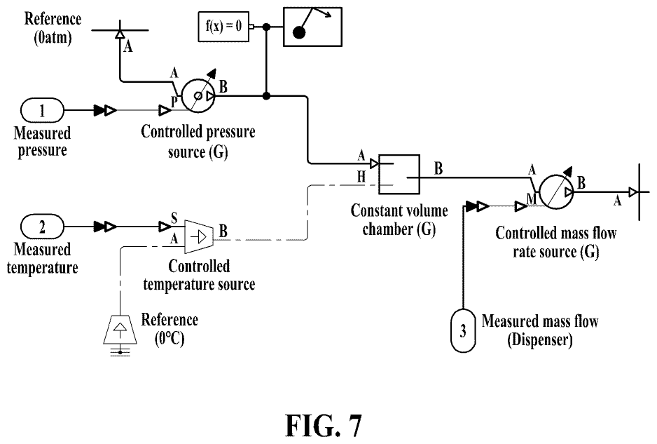

FIG. 7 shows a Simscape-based detailed model for parameter estimation, and the model validation results of the parameter estimation technique for calculating a volumetric efficiency are as follows.

The parameter estimation technique involves receiving measured values from the sensors as input, utilizing engineering equations to estimate target parameters, and determining the residual by comparing the estimated values of the parameters with the nominal values generated in MATLAB Simscape for the parameters. Therefore, the value estimated by [Equation 1] may include signals from the components under abnormal conditions, whereas the nominal value estimated by [Equation 3] does not include signals from the components under abnormal conditions.

As mentioned, the reciprocating compressor of the hydrogen refueling station lacks a sensor to measure the mass flow rate. Thus, the mass flow rate may be indirectly obtained through a numerical analysis model based on the energy conservation equation, using the temperature and pressure measured in the storage container connected to the outlet. The numerical analysis model was developed with MATLAB Simscape.

In order to verify the parameter estimation analysis model, the volumetric efficiency of the compressor from [Equation 1] was compared to the nominal volumetric efficiency measured through the analysis model constructed using MATLAB Simscape.

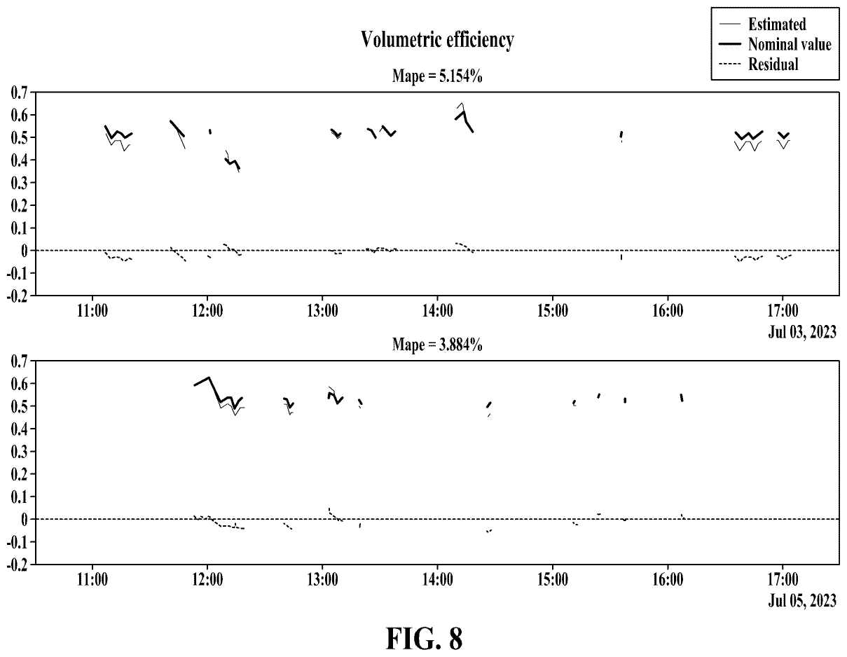

FIG. 8 shows a graph illustrating volumetric efficiency in relation to leaks in a reciprocating compressor cylinder, representing a result calculated based on the measurement data obtained when there was no fault alarm in the hydrogen refueling station. The volumetric efficiency obtained by the numerical model is shown as bold lines (“Nominal value” in FIG. 8) and represents an optimal value of the equipment's measurement data, which is equal to the value when there is no equipment abnormality or disturbance.

The volumetric efficiency obtained from the compression ratio in Equation 1 is indicated by thin lines (“Estimated” in FIG. 8) and is a value measured from the sensor representing the state of the actual equipment. Therefore, this volumetric efficiency may be the target value for diagnosis. The residuals of the two volumetric efficiencies are indicated by dotted lines (“Residual” in FIG. 8). Similarly to the observer-based model, MAPE was used as a performance indicator, showing a high similarity with values of 5.15% and 3.88%, respectively. Additionally, the residual between the two volumetric efficiencies was within 0.05, demonstrating that there was no difference. Therefore, the similarity between the actual equipment and the numerical analysis model was high in the parameter estimation technique.

An experimental example for diagnosing a hydrogen leak fault of a reciprocating compressor according to an embodiment of the present disclosure is as follows.

Reciprocating compressors are prone to hydrogen leaks due to valve or piston failure, so immediate diagnosis is critical. Among the monitoring variables, those that can be easily measured and estimated from the sensors are temperature, pressure, and volumetric efficiency of the reciprocating compressor outlet side. In the case of a leak in a reciprocating compressor outlet valve, the discharge temperature is affected by the reverse flow of the outlet in the intake stroke, and in the case of a leak in a compressor inlet valve, the discharge flow rate is reduced, affecting the discharge pressure.

In addition, the volumetric efficiency within the reciprocating compressor is a measure of the mass flow rate of the cycle in which the piston reciprocates, and it is possible to detect leaks in any part of the compressor. Since the volumetric efficiency decreases by the amount of leakage when a hydrogen leak occurs, the degree of abnormality may be identified.

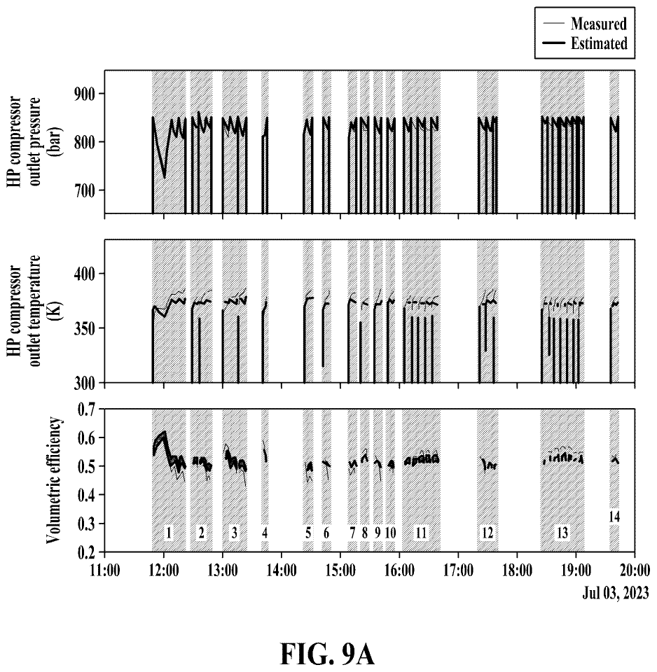

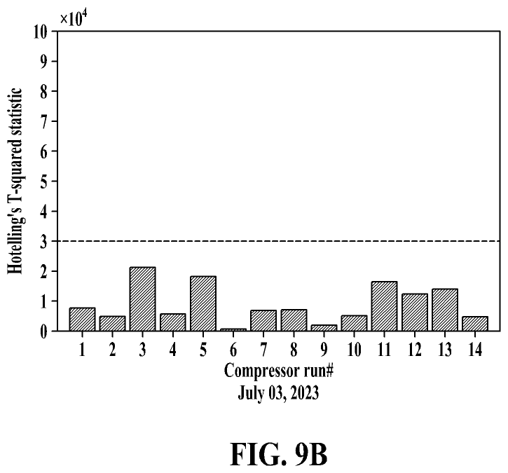

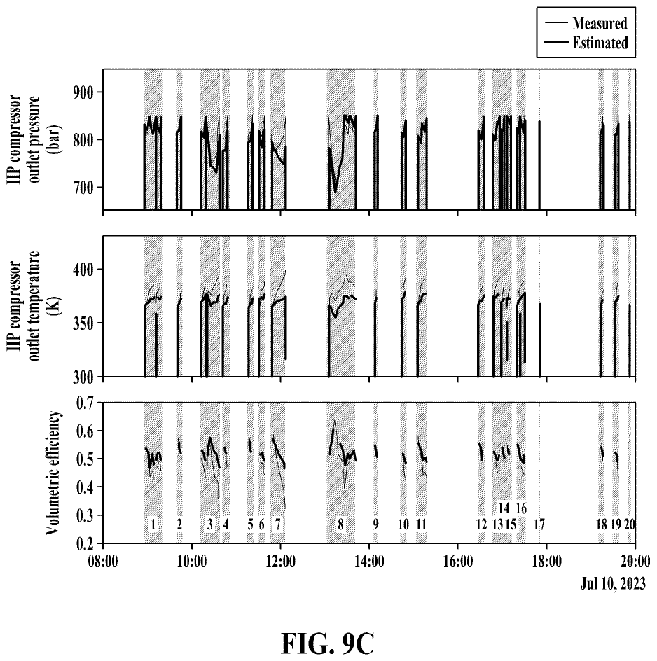

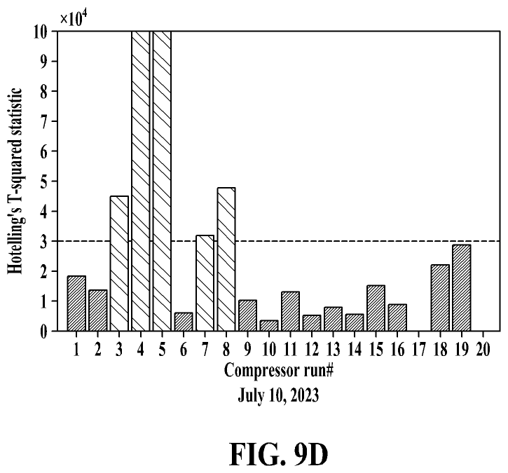

FIG. 9A to FIG. 9D show a comparison result between measurement data and simulation data according to an embodiment of the present disclosure, and FIG. 9A and FIG. 9C show the comparison results between measurement data under normal conditions of a high-pressure compressor in a hydrogen refueling station and measurement data under abnormal conditions where a hydrogen leak has occurred. The thin line indicates the measurement data of discharge temperature, pressure, and volumetric efficiency measured from the actual sensors, and the bold line indicates the temperature and pressure data obtained through the observer technique and the volumetric efficiency data obtained through the parameter technique.

In an experimental example of the present disclosure, the high-pressure reciprocating compressor was operated a total of 14 times during a specific period while no fault history occurred (FIG. 9A). The results of the discharge temperature, pressure, and volumetric efficiency data during this period showed almost no difference.

On the other hand, in FIG. 9C, the measurement data and model-based virtual data are calculated as above for the operation data of the abnormal signals. From the time point of a hydrogen leak, the reciprocating compressor was operated 20 times, the measurement data and model-based virtual data were compared at the 3rd, 4th, 5th, 7th, and 8th operation points, and differences were observed in the discharge temperature, pressure, and volumetric efficiency data of the high-pressure reciprocating compressor.

For accurate fault diagnosis, in addition to single variable measurement, it is additionally necessary to perform multivariate analysis that simultaneously monitors changes in several characteristic values. To verify the significant difference between the multivariate measurement data and the model-based virtual data, a Paired Hotelling T2 test was used, and the T2 statistic is formulated according to the following equation.

$${Y}_{i} = ( {X}_{1 i} - {X}_{2 i} ) / {X}_{2 i} \qquad [ Equation 7 ]$$

$${T}^{2} = n {\overline{Y}}^{′} {{S}_{Y}}^{- 1} \overline{Y} \qquad [ Equation 8 ]$$

The observation sample X1 denotes the measurement data from the sensor of the actual equipment, and X2 denotes the virtual data, which is a model-based estimated value. Y denotes a percentage error of X1 and X2 to fit the scale of each variable. Also, n denotes the number of samples, Ybar denotes the mean vector of Y, and SbarY denotes the variance-covariance matrix, I=1, 2, 3, . . . , n. These are statistical values used to determine whether there is a significant difference between the actually obtained measurement data and the model-based virtual data, and the diagnosis for abnormal conditions may be performed by setting a threshold value.

FIG. 9B and FIG. 9D show the Paired Hotelling T squared statistics values for the normal and abnormal conditions, respectively. The T2 statistics threshold was set to 30,000, and it was confirmed that all cases under the normal conditions were below the threshold, indicating that no fault occurred. On the other hand, for reciprocating compressors with hydrogen leaks, the threshold was exceeded and could be classified as leak data in multivariate analysis.

[Table 3] shows the hydrogen leak point classification and dataset.

Based on the leak history through routine inspections of hydrogen refueling stations for approximately one year from 2022 to 2023, the analysis of the measurement data revealed 34 leaks from the high-pressure reciprocating compressors. Among these, 6 leaks were from the inlet valve, 17 leaks were from the outlet valve, and 11 leaks were from the packing.

Based on this data, for the data statistics associated with faults among the measurement data for one year, data within 24 hours of the leakage occurrence was used, and for the model-based virtual data statistics, the measurement data at the same time point was used to perform a multivariate Hotelling T2-squared test. As a result of the measurement, 373 leak datasets were generated by setting the T2-statistic threshold to 30,000. Additionally, since there was a data imbalance at each leak point, it was addressed using Synthetic Minority Over-sampling Technique (SMOTE), which is one of the oversampling techniques.

TABLE 3

| Date | | | | |
|---|---|---|---|---|
| (Month/Year) | Inlet Valve | Outlet Valve | Packing | Data Set |
| July 2022 | 1 | 1 | 1 | 33 |
| August 2022 | 0 | 2 | 0 | 21 |
| September 2022 | 0 | 1 | 1 | 18 |
| October 2022 | 0 | 1 | 2 | 30 |
| November 2022 | 1 | 2 | 0 | 37 |
| December 2022 | 0 | 0 | 0 | 0 |
| January 2023 | 1 | 1 | 1 | 40 |
| February 2023 | 0 | 1 | 0 | 15 |
| March 2023 | 1 | 2 | 1 | 57 |
| April 2023 | 1 | 3 | 1 | 51 |
| May 2023 | 0 | 1 | 2 | 34 |
| June 2023 | 0 | 1 | 2 | 26 |
| July 2023 | 1 | 1 | 0 | 11 |
| Total | 6 | 17 | 11 | 373 |

Based on the inspection and maintenance data, and with reference to the actual equipment fault history of the hydrogen refueling station, 373 datasets were examined to identify the leak points. Using this information, the residuals of the outlet temperature, pressure, and volumetric efficiency of the reciprocating compressor were determined using observer-based techniques and parameter techniques. To perform exploratory data analysis (EDA), the data distribution was visualized and statistics for each leak point were aggregated.

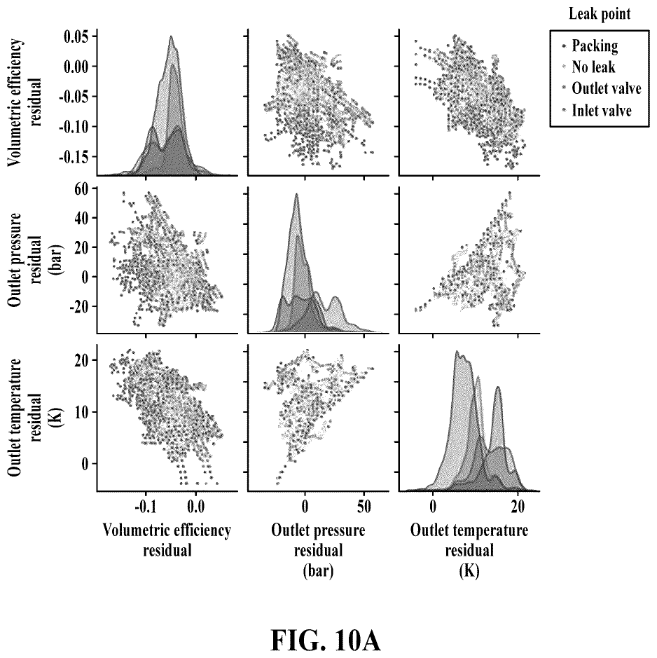

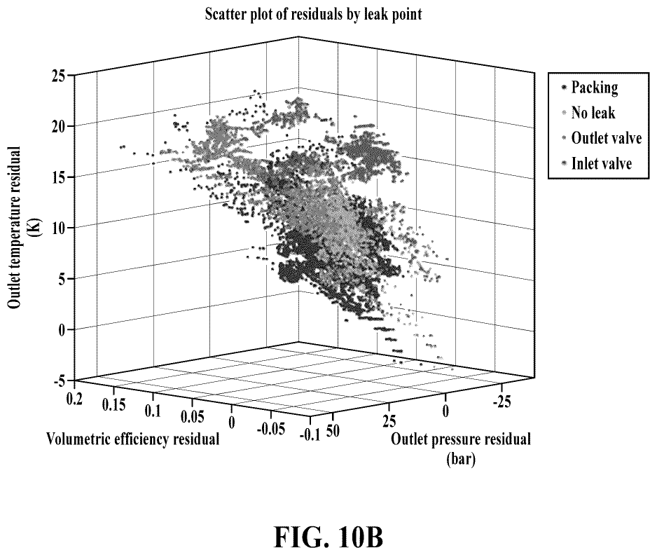

FIG. 10A and FIG. 10B show a distribution and scatter plot for each leak point according to an embodiment of the present disclosure. FIG. 10A and FIG. 10B show the distribution and scatter plot for each leak point, and the scatter plot for each leak point is expressed in a three-dimensional form for three residual variables: volumetric efficiency, discharge pressure, and discharge temperature.

The pair plot shows that for the normal conditions (orange), the volumetric efficiency, pressure, and temperature residuals are well clustered within 0.05, 10 bar, and 10 K, respectively.

For the hydrogen leak in the inlet valve (orange), it was confirmed that the residuals became wider than those under the normal conditions, and for leaks in the outlet valve (yellow) and the packing (purple), it was observed that the range of residual differences became even wider. In the 3D scatter plot of FIG. 10B, clusters are well-formed to the naked eye, and a machine learning classification technique may be applied.

To diagnose the hydrogen leak points, classification was performed using the artificial neural network classification technique, which is one of the machine learning techniques. An artificial neural network is a technique in machine learning that demonstrates high performance in many situations. As the most widely used technique in recent research, the artificial neural network is a network abstracted from neurons, including a network made by connecting small elements of nodes corresponding to artificial neurons. Additionally, the electrical signals of neurons are created in a way that changes the connection relationship according to external stimuli, and this connection relationship is imitated as the connection weight of the node in the neural network. It is a statistical learning algorithm that can generally approximate any form of function.

To train the classifier, 10% of the data was first separated as test data, and the remaining data was divided into 5 groups and cross-validation was performed to prevent overfitting. Neural Network hyperparameters and results are presented in [Table 4].

The tool used to perform machine learning was MATLAB's Statistics and Machine Learning tool box. The input layer size was 25, the number of fully connected layers was 1, the activation function was ReLU, and the iteration limit size was 1000.

TABLE 4

| Model | Hyperparameters | Value | Accuracy (%) | Total cost |
|---|---|---|---|---|
| Neural | First layer size | 25 | 82.5 | 293 |
| Network | Number of fully | 1 | | |
| | connected layers | | | |
| | Activation | ReLU | | |
| | Iteration limit | 1000 | | |

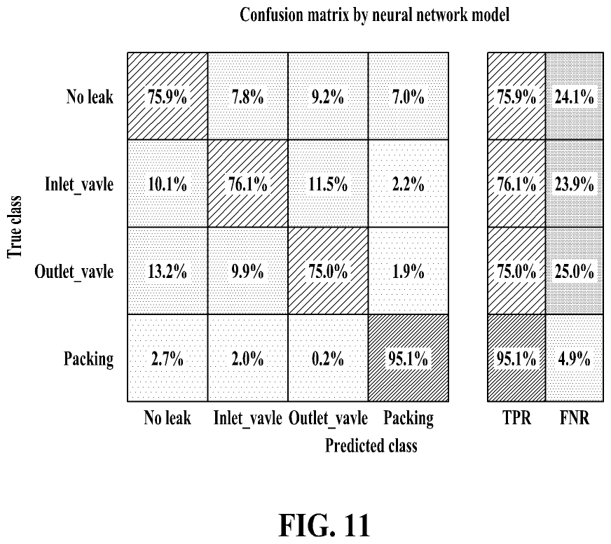

FIG. 11 shows confusion matrix results classified by the neural network technique according to an embodiment of the present disclosure, and [Table 5] shows hyperparameter values and performance results of the neural network. The result of the artificial neural network classification technique showed a high performance with an accuracy of 82.5%.

The classification accuracy for the leak point identified as a packing was the highest at 95.1%, and the remaining classification accuracies were also calculated to be over 75%. Therefore, it can be interpreted that a leak in the packing has a greater effect on the factors of volumetric efficiency, discharge pressure, and discharge temperature than leaks in the inlet and outlet valves.

TABLE 5

| Model | Hyperparameters | Value | Accuracy (%) | Total cost |
|---|---|---|---|---|
| Neural | First layer size | 25 | 82.5 | 293 |
| Network | Number of fully | 1 | | |
| | connected layers | | | |
| | Activation | ReLU | | |
| | Iteration limit | 1000 | | |

The rights of the present disclosure are not limited to the embodiments described above but are defined by the claims, and it is apparent that those skilled in the art of the present disclosure may make various modifications and adaptations within the scope of rights described in the claims.

What is claimed is:

1. A leak detection system for a reciprocating compressor of a hydrogen refueling station in which an outlet is connected to a storage container and pressure within the storage container is maintained at or above a set pressure, the leak detection system comprising:
a data collection module configured to collect measurement data, comprising temperature and pressure from a sensor associated with the reciprocating compressor of the hydrogen refueling station, and a volumetric efficiency, which is a ratio of gas mass drawn into a cylinder during an intake stroke to gas mass corresponding to a stroke volume;
a simulator module configured to perform an operational simulation based on design values of the reciprocating compressor and to generate virtual data comprising temperature, pressure, and volumetric efficiency; and
a data processing module comprising:
a comparator configured to compare the measurement data and the virtual data;
a selector configured to select measurement data corresponding to each hydrogen leak point input based on inspection and maintenance data associated with abnormalities in the reciprocating compressor; and
an estimator configured to estimate abnormal conditions from the measurement data in conjunction with the comparator and the selector.

2. The leak detection system of claim 1, wherein the measurement data and the virtual data further comprise operational information of the reciprocating compressor, motor current, and vehicle pressure and mass flow rate measured at a hydrogen dispenser.

3. The leak detection system of claim 1, wherein the data collection module comprises:
an input section configured to receive specification information of the reciprocating compressor; and
a calculation section configured to calculate the volumetric efficiency based on the specification information, a gas mass flow rate, a density, and a nominal stroke volume, wherein the gas mass flow rate is determined by applying a mass flow rate estimated based on mass and energy conservation equations at the pressure and temperature of the storage container.

4. The leak detection system of claim 1, wherein the maintenance data comprises leaks in an inlet valve, an outlet valve, and a cylinder packing.
